(19) United States
(12) Patent Application Publication
(10) Pub. No.: US 2019/0210886 A1
(43) Pub. Date: Jul. 11, 2019

(54) LANTHANIDE-DOPED FLUORIDE NANOCOMPOSITES, PRODUCTION METHOD AND APPLICATIONS

(71) Applicant: National Yang-Ming University, Taipei City (TW)

(72) Inventors: Cheng Allen CHANG, Taipei City (TW); Syue-Liang LIN, Taipei City (TW); Chang-Chieh HSU, Taipei City (TW)

(21) Appl. No.: 16/004,949

(22) Filed: Jun. 11, 2018

(30) Foreign Application Priority Data
Jan. 11, 2018 (TW) 107101088

(51) Int. Cl. C01F 17/00

(52) U.S. Cl. CPC C01F 17/0031; B82Y 30/00; C01P 2002/52; C01P 2004/34

(57) ABSTRACT

The present invention provides a lanthanide-doped fluoride nanocomposite, which comprises: a core layer, is consisting of a first compound, wherein the first compound has a sodium fluoride compound with a base material, a first lanthanide metal and a second lanthanide metal; a middle layer covering the core layer, is consisting of a second compound, wherein the second compound has a sodium fluoride compound with the base material and the first lanthanide metal; and an outer shell layer covering the middle layer, is consisting of a third compound, wherein the third compound has a sodium fluoride compound with the base material and the first lanthanide metal or a third lanthanide metal.

### CROSS-REFERENCE TO RELATED APPLICATIONS

This Non-provisional application claims priority under 35 U.S.C. § 119(a) on Patent Application No(s). 107101088 filed in Taiwan, Republic of China Jan. 11, 2018, the entire contents of which are hereby incorporated by reference.

### FIELD OF THE INVENTION

The present invention relates to a nanocomposite technology can be applied to the field of clinical tumor diagnosis, photodynamic therapy, and light energy conversion.

### BACKGROUND OF THE INVENTION

According to the statistics of National Institutes of Health (NIH) from 2011 to 2014, the top ten causes of death among people of the world are almost malignant tumors. Currently, there are several therapies for the treatment of malignant tumors: (1) surgical resection; (2) chemical treatment, however, the invasive surgical procedures are with high side effects and the chemotherapy may have drug resistance. It is not suitable for older or weaker patients due to the shortcomings; (3) radiation therapy, although the risk is lower than the above two methods, however, because the energy was already released before it reaches the target lesion, the X-ray would damage normal tissues; and (4) target therapy, there are also drug resistance issues exited in this therapy; and (5) other therapies, such as immunotherapy, photodynamic therapy and hyperthermia. In addition, in recent years, from research on green energy and solar energy has required materials for efficient energy conversion. Therefore, scientists have been devoting themselves to developing other kinds of therapy for humankind.

Based on the previous research, photodynamic therapy was an alternative method being applied to cancer treatment, which refers to the light source in a specific wavelength range to generate singlet oxygen and free radicals upon irradiation with a photosensitizer, thereby to kill tumor cells. In photodynamic therapy, the photosensitizer would be injected intravenously or subcutaneously into the body, due to the different characteristics of tumor cells/microenvironment and normal cells/tissues, the photosensitizer would tend to gather in the tumor and then kill the tumor by light irradiation. The currently available excitation light for common photosensitizers is usually located in the ultraviolet or visible wavelength range, and these light cannot penetrate deeper layers of the skin, thus resulting in the limited application of photodynamic therapy. Another photothermal therapy derived from photodynamic therapy also has the advantage of having low side effects by targeting a photothermal sensitizers to the tumor and irradiating it with light of a particular wavelength that absorbs the light and converts the light into heat resulting in localized tissue to 42° C. above for several minutes to destroy tumor cells. The current mainstream of photothermal sensitizers is using the excitation light in the visible range but is lack of targeting function in clinic, so the precise treatment of deep tissue is still very difficult. Thus, there is no appropriate light therapy can enhance the local anti-cancer effect with specificity.

Lanthanide metals have a longer lifetime (μs-ms) in luminescence signal that can filter the interference of autofluorescence of organisms by time-resolved luminescence imaging methods, so as to increase the signal-to-noise ratio and sensitivity. Therefore, the application of lanthanide metal materials as luminescent probes and applied to optical imaging is very potential in research. Lanthanide ions also have a large stokes shift, which emits light of a f-f transition from the 4f orbital to less susceptible to the environment, so that the luminescence spectrum has a narrow wavelength range and is in high specificity. The wavelength of photon is pure and the discrimination is high from it, which makes it very suitable for the use of luminescence imaging, and its green energy and solar energy conversion applications also have great potential.

The research of Lanthanide doped nanoparticles began in the late 1990s as they had better luminescence properties than other fluorescent probes due to their large stokes shift and scintillation properties. Lanthanide doped nanomaterials developed rapidly in related research. However, at present, the luminescent and pyrogenic efficiency of lanthanide doped nanoparticles and photothermal sensitizers needs to be improved, and the effect of radiotherapy and treatment cannot be obtained simultaneously. The traditional photodynamic therapy produces reactive oxygen species for killing cancer cell by visible light excitation of the photosensitizers. However, the wavelength of 400-700 nm visible light easily absorbed and scattered by the biological tissue, so the scope of photodynamic therapy is currently limited to the treatment of superficial cancers such as melanoma.

The present invention is aim to the problems of luminescent light up and down and conversion energy transfer efficiency, as well as the problems of diagnostic and therapeutic functions and the problem of photo-bleaching of organic dyes. Based on the luminescent material of NaLnF₄, a series of lanthanide metal fluoride nanocomposites were studied, including Ln, Gd, Y, Lu, Nd, Yb, Er, Tm, Eu and Tb. Through the advantages of low scattering, with good contrast effect of NIR. The near-infrared light image in biological tissue shows its high penetration, low scattering advantages and good results with signal-to-noise ratio.

### SUMMARY OF THE INVENTION

The present invention provides a method of using a combination of a photosensitizer (such as Rose Bengal, TiO₂, etc.) and a photothermal sensitizer (such as NIR dye, AuNPs). Nanomaterials containing lanthanide ions are integrated into variety of nanocomposites for non-invasive and deep-tissue photodynamic therapy and photothermal therapy, as well as oncology assessments of therapies and real-time images of therapies as a new theranostic agents. In addition, the nanocomposite material of the technology platform can also be combined with the customized targeting molecule to form a targeting nano system according to actual needs, so as to improve the success rate of cancer theranostics and bring new potential method for clinical cancer treatment.

Therefore, please refer to FIG. 1, the present invention provides a lanthanide-doped fluoride nanocomposite, which comprises the structure of: a core layer, is consisting of a first compound, wherein the first compound has an alkali fluoride compound with a base material, a first lanthanide metal and a second lanthanide metal; a middle layer covering the core layer, is consisting of a second compound, wherein the second compound has the alkali fluoride compound with the base material and the first lanthanide metal; and an outer shell layer covering the middle layer, is consisting of a third compound, wherein the third compound has the alkali fluoride compound with the base material and the first lanthanide metal or a third lanthanide metal.

Preferably, the first compound is NaLnF₄:Yb³⁺,Er³⁺, NaLnF₄:Yb³⁺,Nd³⁺, NaLnF₄:Gd³⁻,Eu³⁺or NaLnF₄:Eu³⁺, wherein Ln represents the base material is selected from the group of Y, Gd, La, Lu and lanthanide.

In one of the present invention, when the first compound is NaLuF₄:Gd³⁻,Eu³⁺, the second compound is NaLuF₄:Gd³⁺, and the third compound is NaLuF₄:Gd³⁻,Tb³⁺.

Preferably, the mole percentage of Gd³⁺ Eu³⁺ in the first compound is 20%˜50% and 5%˜30%; the mole percentage of Gd³⁺ in the second compound is 20%˜50%; wherein the mole percentage of Gd³⁺ and Tb³⁺ in the third compound is 20%˜50% and 5%˜30%.

In one of the present invention, when the first compound is NaYF₄:Yb³⁺,Er³⁺, the second compound is NaYF₄:Yb³⁺, and the third compound is NaYF₄:Nd³⁺,Yb³⁺.

Preferably, the mole percentage of Yb³⁺ and Er³⁺ in the first compound is 5%˜50% and 0.2%˜5%; the mole percentage of Yb³⁺ in the second compound is 5%˜50%; wherein the mole percentage of Nd³⁺ and Yb³⁺ in the third compound is 5%˜50% and 5%˜50%.

In one of the present invention, when the first compound is NaYF₄:Yb³⁺,Nd³⁺, the second compound is NaYF₄:Yb^{3 +} and the third compound is NaYF₄:Yb³⁺,Tm³⁺.

Preferably, the mole percentage of Yb³⁺ and Nd³⁺ in the first compound is 5%˜50% and 5%˜20%; the mole percentage of Yb³⁺ in the second compound is 5%˜50%; wherein the mole percentage of Yb³⁺ and Tm³⁺ in the third compound is 5%˜50% and 0.2%˜5%.

In one of the present invention, when the first compound is NaYF₄:Yb³⁺,Nd³⁺, the second compound is NaYF₄:Yb³⁺, and the third compound is NaYF₄:Yb³⁺,Er³⁺.

Preferably, the mole percentage of Yb³⁺ and Nd³⁺ in the first compound is 5%˜50% and 5%˜20%; the mole percentage of Yb³⁺ in the second compound is 5%˜50%; wherein the mole percentage of Yb³⁺ and Er³⁺ in the third compound is 5%˜50% and 0.2%˜5%.

In one of the present invention, when the first compound is NaGdF₄:Eu³⁺, the second compound is NaGdF₄:Ce³⁺, and the third compound is NaGdF₄:Tb³⁺.

Preferably, wherein the mole percentage of Eu³⁺ in the first compound is 5%˜30%; the mole percentage of Ce³⁻ in the second compound is 5%˜50%; wherein the mole percentage of Tb³⁺ in the third compound is 5%˜30%.

Preferably, the outer shell layer is modified by a polyallylamine hydrochloride, poly acrylic acid, silicon dioxide or titanium oxide.

Preferably, the surface of the shell layer is further modified with a photosensitizer or a photothermal sensitizer.

Preferably, the surface of the shell layer is further coated with a biocompatible molecule and links a target molecule.

Besides, please refer to FIG. 2, the present invention provides a method of making a lanthanide-doped fluoride nanocomposite, which comprising the steps of:

a) Step S201, preparing a core layer by mixing 0.25-1 millimole of a basic acetate with 6-10 milliliters of oleic acid and 15 mL of octadecene, further doping a first lanthanide metal or a second lanthanide metal, then obtaining a first solution;

b) heating the first solution in 160° C.˜190° C. for a period of time, the reaction temperature was reduced to 65° C.;

c) step S202, dissolving 2.5 mmol of sodium hydroxide (NaOH) and 4 mmol of ammonium tetrafluoride (NH4F) in 10 ml of methanol to obtain a second solution;

d) step S203, adding the second solution into the first solution and evaporating the methanol completely to obtain a third solution;

e) heating the third solution in 280° C.˜310° C. for a period of time, the reaction temperature was reduced to room temperature;

f) step S204, adding 15˜25 mL of ethanol into the third solution to precipitate, collecting a precipitated product after the reaction is completed;

g) step S205, adding the precipitated product into a non-polar solvent to obtain a first compound, wherein the first compound is the core layer;

h) step S206, preparing a middle shell, further doping said first lanthanide series metal, and repeating steps a) to g) to obtain a second compound which is used as the middle shell covering said core layer; and

i) preparing a shell layer, further doping the first lanthanide series metal or the third lanthanoid series metal, repeating steps a) to g), obtaining a third compound which is used as the outer shell layer covering the middle shell layer, then obtaining a core-shell nano material.

One embodiment of the present invention indicates the method of making the middle layer and outer layer of the lanthanide-doped fluoride nanocomposite, which comprising the steps of:

a) Preparing a core layer by mixing 0.25 millimole of a basic metal acetate with 6-10 milliliters of oleic acid and 15 mL of octadecene, further doping a first lanthanide metal or a second lanthanide metal, then obtaining a first solution;

b) heating the first solution in 160° C.˜190° C. for 0.5˜1 hr, the reaction temperature was reduced to 65° C.;

c) Dissolving 2.5 mmol of sodium hydroxide (NaOH) and 4 mmol of ammonium tetrafluoride (NH4F) in 10 ml of methanol to obtain a second solution;

d) Adding the second solution and 0.1˜0.5 mmol of first compound/second compound into the first solution and evaporating the methanol completely to obtain a third solution;

e) heating the third solution in 280° C.˜310° C. for a period of time, the reaction temperature was reduced to room temperature;

f) Adding 15˜25 mL of ethanol into the third solution to precipitate, collecting a precipitated product after the reaction is completed by centrifugation (4000 rpm for 5 min) and then washing the precipitate by alcohol for twice;

g) centrifugation again (4000 rpm for 8 min), then adding the precipitated product into a non-polar solvent to obtain a second compound/third compound, which is used as the outer shell layer covering the middle shell layer, then obtaining a core-shell nano material.

The above five materials using a new core-shell structure to enhance luminescent efficiency and energy transfer efficiency, can be excited by the excitation light source (such as X-ray, near infrared (NIR) (Cherenkov radiation, CR) with good penetration of biological tissue. Thus, the problem of inadequate penetration and photothermal effects caused overheating from the UV light, visible light and other excitation light could easily be absorbed by biological tissue in traditional photodynamic/photothermal therapy.

In addition, the above materials can be surface modified by polymers (such as Polyallylamine hydrochloride, PAH)/silicon dioxide (SiO2), and combined with the photosensitizers (such as Rose Bengal (Rose)/TiO2 (TiO2)) or photothermal reagents (such as IR806) to absorb the luminescence of the nanoparticles to generate singlet oxygen/reactive oxygen species (ROS)) or heat for traditional photodynamic therapy and/or photothermal therapy of deep tissues. The purpose of the present invention is to hopefully overcome the limitation of the photodynamic therapy and photothermal therapy, which can only be applied to the subcutaneous shallow layer (less than 1 cm). The above embodiments 2, 3 and 4 are excited by 793 nm near-infrared light and have a penetration ability to the dermal layer. While embodiments 1, 5 were excited by X-ray and cherenkov radiation, respectively, with no limitation on the depth of penetration in biological tissues. On the other hand, near infrared luminescence can be used for imaging with the light waves that are not easily absorbed by the light-sensitive substance, so as to achieve diagnosis and treatment simultaneously (theranostics). In summary, the present invention can provide a deeper treatment on photodynamic therapy, photothermal therapy and luminescent imaging diagnosis than traditional therapy, and shorten the waiting time between diagnosis and treatment by using X-ray, near-infrared light and high penetrating excitation light sources such as cherenkov radiation. Besides, the immediate assessment of treatment can be provided quickly as a reference for subsequent treatment, which reduces treatment time and medical costs.

The present invention replaces the visible light or 980 nm near-infrared light used in other inventions in the past with near-infrared light (780-806 nm), X-ray or cherenkov radiations to excite the nanocomposite. Besides, based on the principle of energy transfer, the new luminescent shell structure has been developed to enhance the efficiency of singlet oxygen generation and photothermal therapy in the photodynamic therapy. Nanocomposites are used in cancer cells (MDA-MB-231, MCF-7 and other cell lines are implemented in the embodiment of the present invention), a larger amount of singlet oxygen is excited by energy to cause cell apoptosis. The present invention also integrates the composite material for diagnosis (such as near-infrared luminescence imaging, CT image) and treatment (such as photodynamic therapy and photothermal treatment) is on the same nanocomposite, and uses high penetrating power (near infrared light, X-ray, cherenkov radiation) to enable the simultaneous diagnosis and treatment of the multiple functions (theranostics).

### BRIEF DESCRIPTION OF THE DRAWINGS

FIG. 1 shows the structure of lanthanide-doped fluoride nanocomposite of the present invention.

FIG. 2 shows the synthesis process of lanthanide-doped fluoride nanocomposite of the present invention.

FIG. 3a shows the amount of singlet oxygen generated after irradiation of the material of the present invention with an excitation light (X-ray).

FIG. 3b shows the temperature increase of the inventive material after irradiation with near-infrared light (NIR) of the present invention.

FIG. 3c shows the photothermal temperature variation of different concentrations of the present inventive material over time

FIG. 4a shows the effect of the present inventive material on cell viability after X-ray irradiation

FIG. 4b shows the effect of the material of the present invention on cell viability after irradiation with NIR

FIG. 5a shows the material composition of the first embodiment of the present invention

FIG. 5b shows the experimental test result of the first embodiment of the present invention

FIG. 6a shows the material composition of the second embodiment of the present invention

FIG. 6b shows the experimental test result of the second embodiment of the present invention

FIG. 7a shows the material composition of the third embodiment of the present invention.

FIG. 7b shows the results of the tests of the third embodiment of the present invention.

FIG. 8a shows the material composition of the fourth embodiment of the present invention.

FIG. 8b shows the test results of the fourth embodiment of the present invention.

FIG. 9a shows the material composition of the fifth embodiment of the present invention.

FIG. 9b shows particle size analysis results of the fifth embodiment of the present invention.

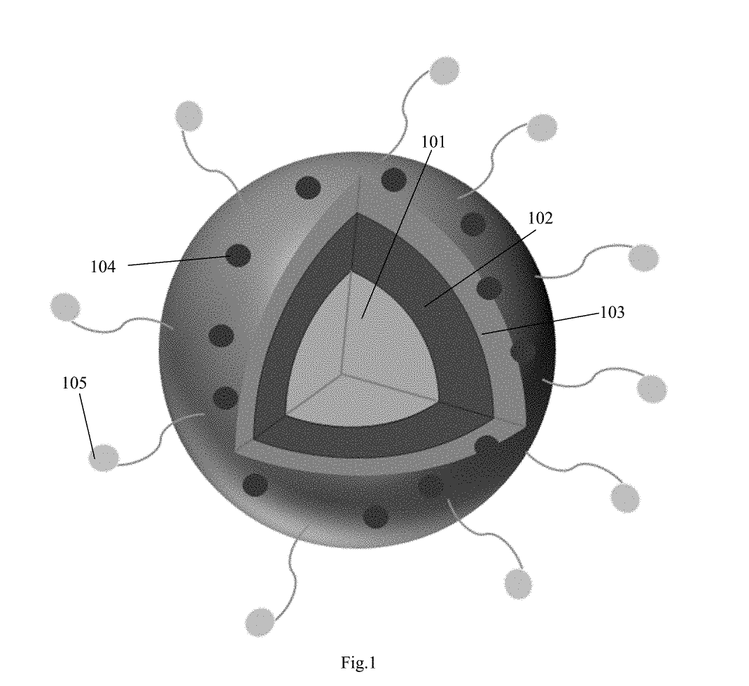

### DETAILED DESCRIPTION OF THE INVENTION

Based on the luminescent properties of lanthanide-based metals, the present invention establishes a nanocomposite technology platform based on lanthanide-based metal nanoparticles. The lanthanide-based metal material is combined with photosensitizers and photothermal sensitizers so as to have a higher tissue penetrability. The high excitation light source excites the lanthanide metal so that the luminescence emitted by the lanthanide metal can be more effectively absorbed by the photosensitizer and the photothermal sensitizer to thereby improve the problem of insufficient light penetration of the conventional directly-excited photosensitizer and the photothermal sensitizer. Besides, the higher penetration of near-infrared light can be used in luminescence imaging, photodynamic therapy and photothermal therapy. The technical platform of the invention uses the 780-806 nm near-infrared light, the X-ray and the Chevrolet radiate which are better than traditional light sources as the excitation light source for diagnosis and treatment.

1. The Preparation of Core-Shell Nanomaterial

Nanoparticles are synthesized by pyrolysis, and 1 mmol of precursor (lanthanide acetate, an acetate containing at least one member selected from the group consisting of Y, Gd, La, Lu and lanthanide series metal elements Salt) is mixed with oleic acid and octadecene in a mole percentage, and further, the first lanthanide metal such as Gd, Yb or Ce, or the second lanthanide metal such as Eu, Er or Nd. The reaction is heated at 190° C. for one hour, and then the reaction temperature is reduced to 65° C., followed by sodium hydroxide (NaOH, 2.5 mmol) and amine tetrafluoride (NH4F, 4 mmol) to be uniformly mixed. Then, adjust the temperature to 280° C.˜310° C. to react for 1˜1.5 hours, then wait for the temperature dropped to room temperature to obtain the core of the core product. Thereafter, using similar methods, different combinations of cladding shell structures are coated based on the above core layer.

2. The Surface Modification of the Core-Shell Nanomaterial

In one of the embodiment of the present invention, the surface of the core-shell nanomaterial can be modified with TiO2 surface. The porous silica preparation process comprises the following steps: adding 2 mg˜20 mg unmodified nanometer material into 0.1-1 g CTAC or CTAB and deionized water 25 mL, ultrasonic oscillation for 0.5 hr; adding ethyl acetate 0.5 to 1.5 mL and sodium hydroxide (2 M, 150 μL), heating to 70° C., and then slowly adding tetraethylsilane (TEOS) 50˜200 μL reaction for 3 to 5 hours; after the reaction, washing with ethanol and purify by centrifugation, and washing the template molecule CTAC or CTAB with 50 ml of ammonium nitrate ethanol solution (6 g/mL) at 60° C. The obtained titanium dioxide coating and porous silica coated shell nanomaterials were dispersed in ethanol, and added 10˜60 ul of 3-aminopropyl triethoxysilane (APTES) or polyallylamine hydrochloride (PAH), the reaction 24 h, and then washed with ethanol unreacted material; the product dispersed in water or ethanol, adding a polymer containing NHS functionalized PEG/photosensitizers/photothermal sensitizers biochemical bonding peptide bonds, stirring for 24 hours, the solvent was washed away unreacted material.

The core-shell material was modified TiO2 surface, which steps include: using anti-micro-first way to modify the surface of the silica nano-material; adding 20˜25 ml n-hexane or cyclohexane into 1˜1.5 ml Interface Igepal CO-520, and magnetically stirred (500˜1000 rpm); Adding 5˜20 mg of the aforementioned nanomaterials, after mixing evenly through the magnet into the ultrasonic bath; adding 100˜200 ul of NH4OH and then slowly add 80-200 ul of silica precursor TEOS for 24 hours at room temperature. Precipitate was precipitated by adding ethanol and centrifuged (9500 rpm for 20 minutes) and washed several times with ethanol. The product was stored in ethanol;

In addition, 50˜100 ul NH4OH was added into the silica material containing nanomaterials modified ethanol shell solution; after magnetically stirred for 30 minutes, slowly added titanium dioxide precursor TBOT (Titanium (IV)) 200 ul at 45° C., magnetically stirred for 12 hours after centrifugation and washed unreacted material with ethanol, the nano-material having a TiO2 shell was dispersed in water; after reaction in 180° C. for 6 hours in a furnace, washed with ethanol and centrifuged to collect the reaction product, then the product was stored in ethanol.

3. Singlet Oxygen Generation and Temperature Increase Test

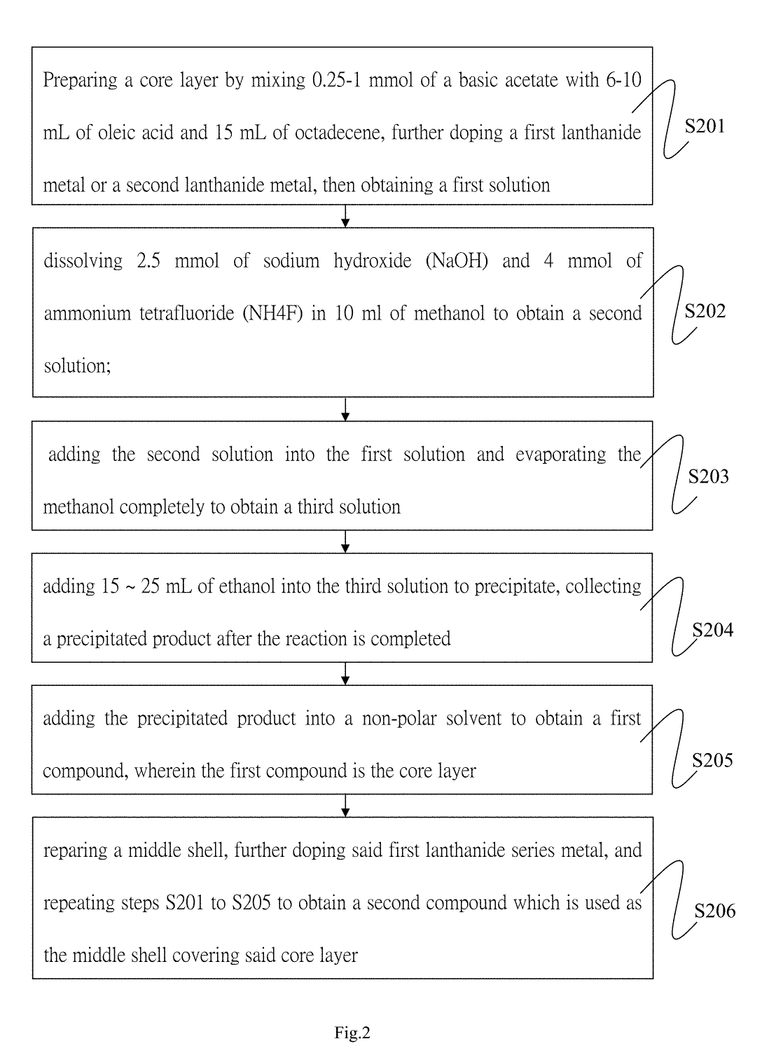

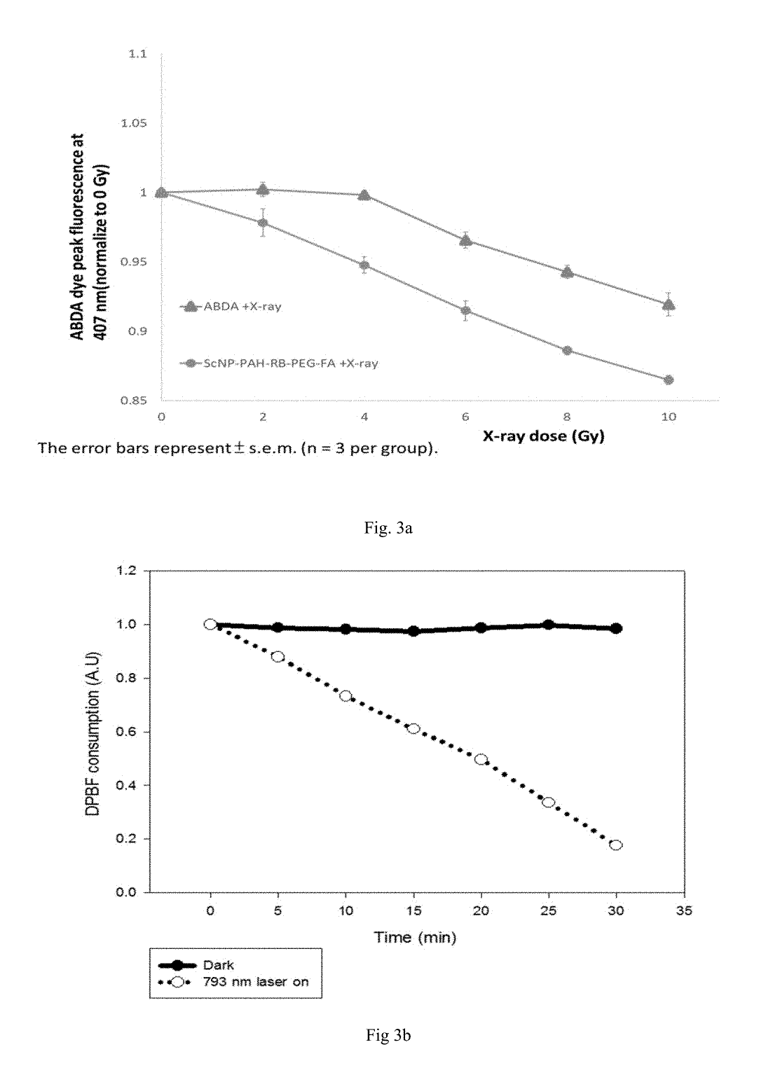

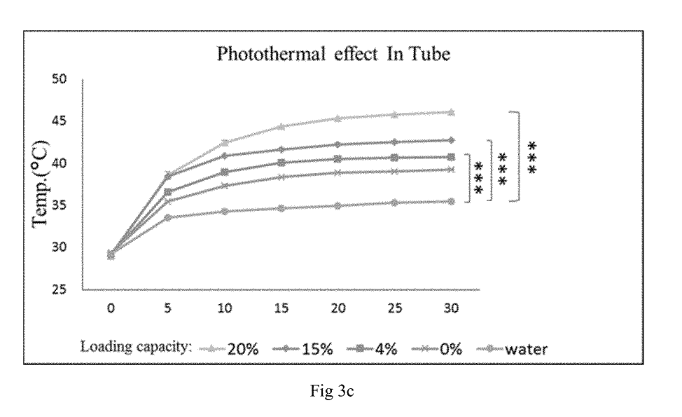

As shown in FIGS. 3a and 3b, the prepared nanocomposite of the present invention is excited with a pre-designed excitation light (X-ray) or near-infrared light (NIR) as a light source, and singlet oxygen reagent (DPBF, 1,3-Diphenylisobenzofuran) was used to measure the singlet oxygen production effect. Also, as shown in FIG. 2c, the photothermal therapy nanocomposite was irradiated with near-infrared light (NIR) to measure the temperature increase of the solution to test the temperature increasing effect.

4. The Cytotoxicity Analysis

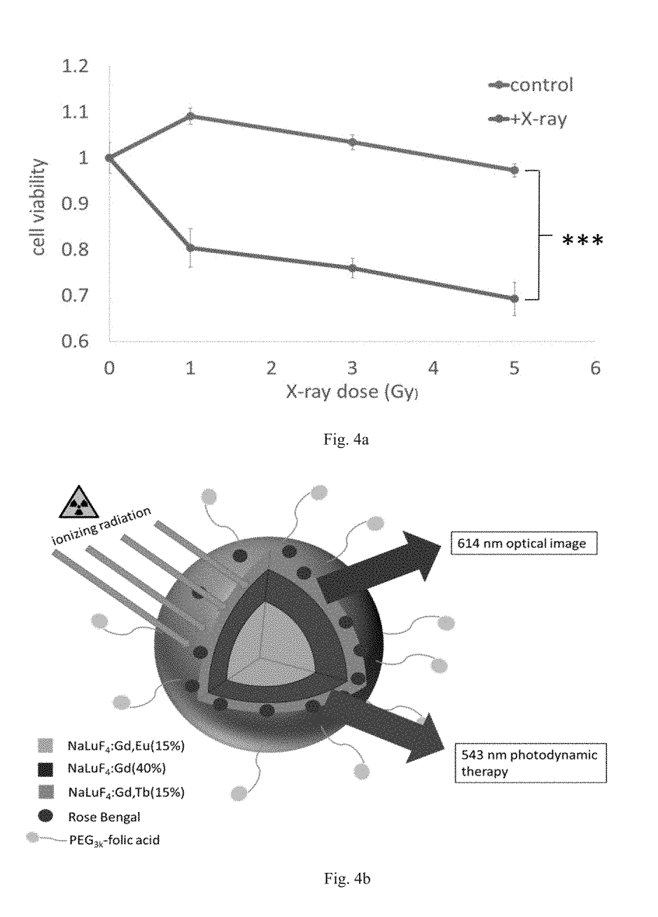

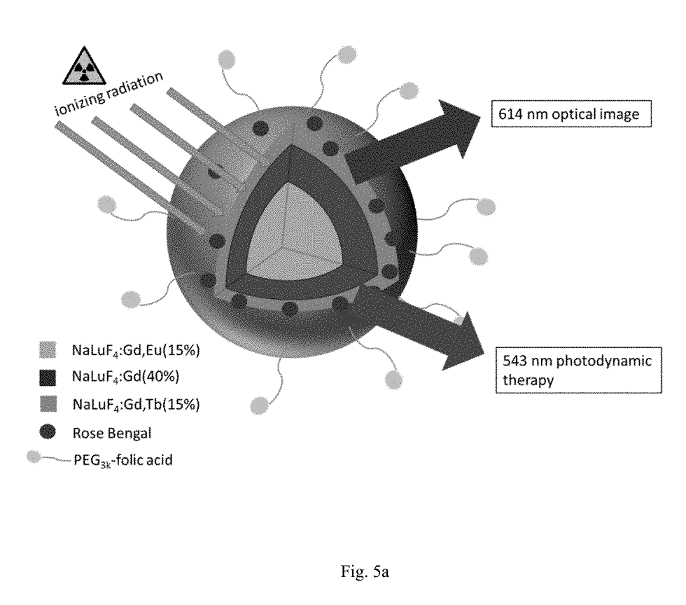

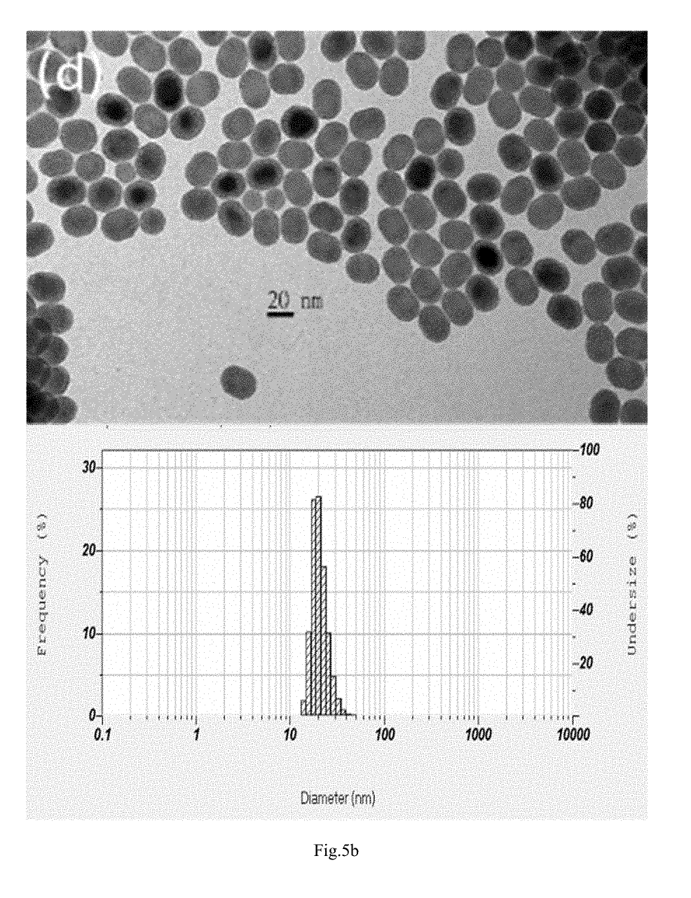

Breast cancer cell line MDA-MB-231 was seeded in a 96-well plate. After culturing for 24 hours, the medium was removed and fresh medium (containing different concentrations of nanoparticles) was added, and then cultivation for 24 hours. Afterwards, the medium was removed and CCK-8 reagent (10X diluted in DMEM) was added and incubated in an incubator for two hours, measured 450 nm absorbance and calculate the cell viability by a multi-functional analyzer and the cell dark toxicity can be known. During the Cell Light Treatment Experiment, 104 cells/well of breast cancer cell line MDA-MB-231 was planted in a 96-well plate. After culturing for 24 hours, the medium was removed and fresh medium (containing 10 to 500 μg/mL of nanoparticles), and then cultured for 24 hours. As shown in FIG. 4a the nanocomposites that were not phagocytized by the cells were washed away and the cells were irradiated with X-ray (0.1 to 3 Gy dose for 30 minutes), and NIR (1 W/cm2 for 30 minutes) as shown in FIG. 4B. After stopping the light irradiation, incubated the cells for an additional 24 hours, then remove the medium, add CCK-8 reagent (10X diluted in DMEM) and incubate the cells in incubator for two hours. Multi-functional analyzer measured 450 nm light absorption and calculate cell viability, the light induced treatment effect can be known.

Please refer to the following examples, the present invention provides five different combinations of nanocomposites for tumor treatment and efficacy evaluation.

### EXAMPLE 1

The structure of the present invention comprises NaLuF4:Gd3+(20-50%), Eu3+(5-30%) @ NaLuF4:Gd3+(20-50%)@NaLuF4: Gd3+), Tb3+(5-30%) @ PAH-RB @ PEG-folic acid with both fluoroscopic and photodynamic therapy efficacy and a core-shell-shell structure.

As shown in FIG. 5a, X-ray irradiation can be used to emit 543 nm and 614 nm dual-band light via energy transfer. Among them, 543 nm green light (purple arrowheads) can be induced by the outer layer of Rose Bengal to induce the generation of ¹O₂ and ROS for photodynamic therapy, and 614 nm red light (red arrow) can be applied to luminescent imaging. Again, as shown in FIG. 5b, the particle size analysis results were 21 nm (core) and 28.9 nm (core/shell/shell), respectively. The formation of ¹O₂ and ROS was measured, and the amount of ABDA luminescence decreased by 14%, confirming the production of reactive oxygen species. The phototoxicity of cells showed 35-45% of the experimental group and 50-60% of the control group under the same conditions.

### EXAMPLE 2

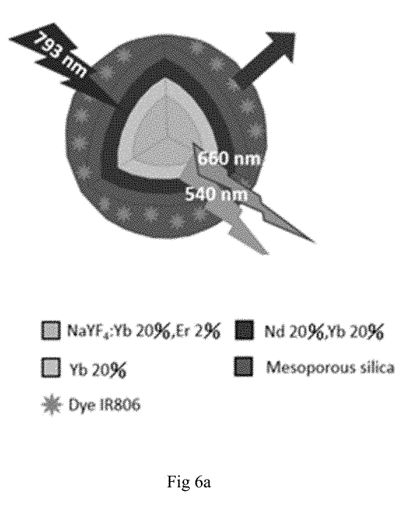

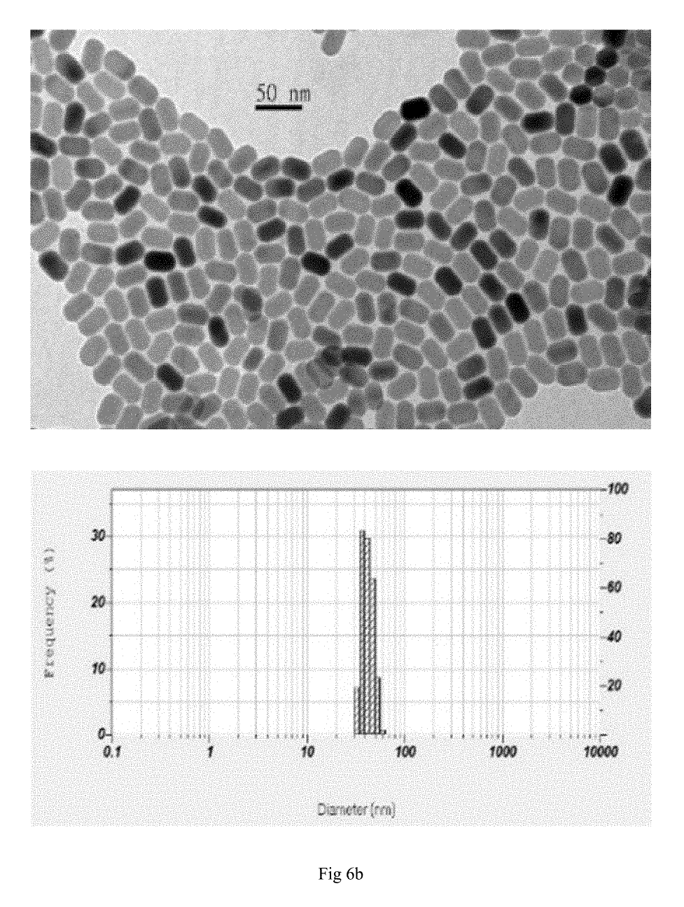

The structure from the core layer to the outer shell of the order of NaYF4: Yb3+(5-50%), Er3+(0.2-5%) @ NaYF4: Yb3+(5-30%) @ NaYF4: Nd3+), Yb3+(5-50%) @ mSiO2-IR806-PAH @ PEG-folic acid. As shown in FIG. 6a, using a novel material design, 780-806 nm near-infrared light is used as an excitation light source to enhance the contrast function in photothermal therapy. As shown in FIG. 2b, using near-infrared laser irradiation, 540 nm and 660 nm dual-band light are emitted as luminescence imaging by energy transfer. As shown in FIG. 6b, the particle size analysis results were 27.3 nm (core) and 42.3 nm (core/shell/shell), respectively. The temperature was raised by 17.2° C., confirming the generation of heat, while the phototoxicity of cells showed that the experimental group was 40-60% under the same conditions and 85-95% in the control group.

### EXAMPLE 3

The structure is composed of core layer to the outer shell layer in order of NaYF4: Yb3+(5-50%), Nd3+(5-50%) @ NaYF4: Yb3+(5-50%) @ NaYF4: Yb (0.2-5%) @ dSiO2- @ mTiO2 @ PAH @ PEG-folic acid. The use of TiO2 shell modified on the surface of upconverting luminescent nanoparticles, which is different from the traditional method of particle adsorption, can increase the TiO2 content and surface stability, and the production of reactive oxygen species (ROS) can achieve better photodynamic therapy effect.

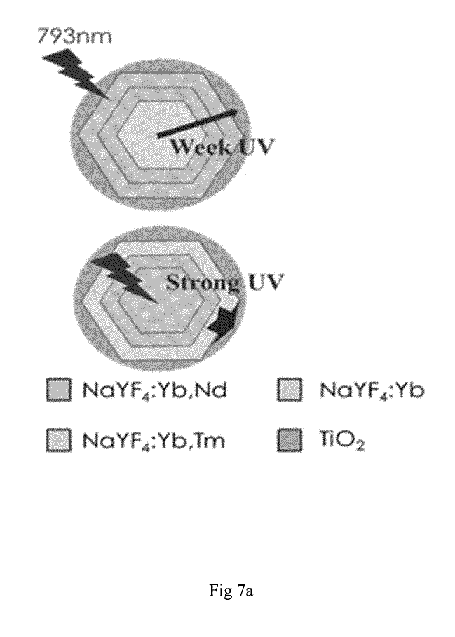

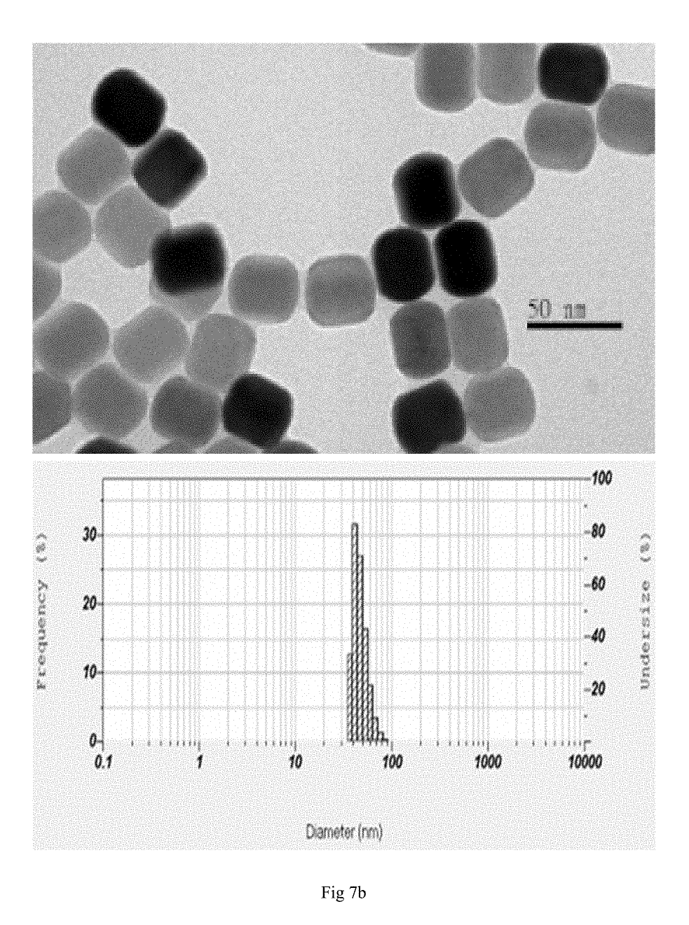

As shown in FIG. 7a, near-infrared light irradiation can be used to emit light in the 350 nm and 450 nm bands via energy transfer. Its luminescence can be absorbed by the outer layer of TiO2 induced ROS generation to facilitate photodynamic therapy. As shown in FIG. 7b, the particle size analysis results were 27.3 nm (core) and 37.2 nm (core/shell/shell), respectively. The generation of reactive oxygen species (ROS) was measured by measuring 23% of the amount of ABDA luminescence. The photo-cytotoxicity assay showed that the experimental group was 40-45% under the same conditions and the control group was 80-90%.

### EXAMPLE 4

The structure is composed of core layer to the outer shell layer in order of (5-50%) @ NaYF4:Yb3+(5-50%) @ NaYF4:Yb (5-50%)@NaYF4: Yb3+), Er3+(0.2-5%) @ PAH-RB @ PEG-folic acid. The luminescent shell on the surface layer, can solve the Förster resonance energy transfer efficiency problems.

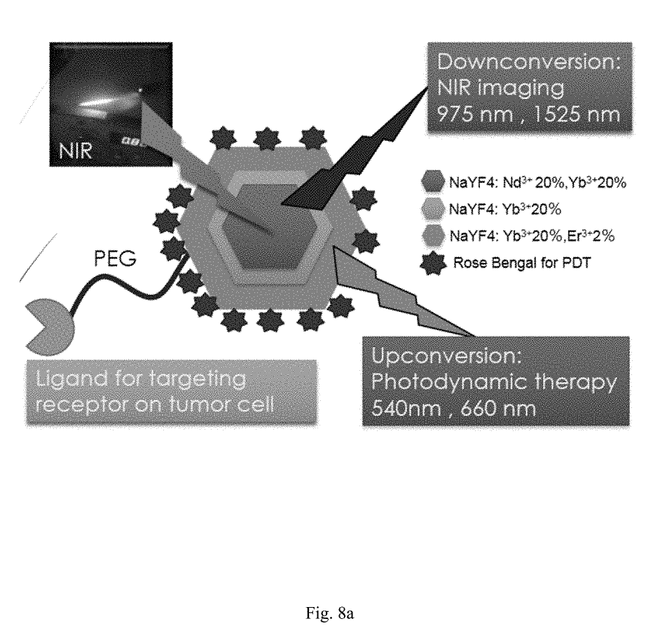

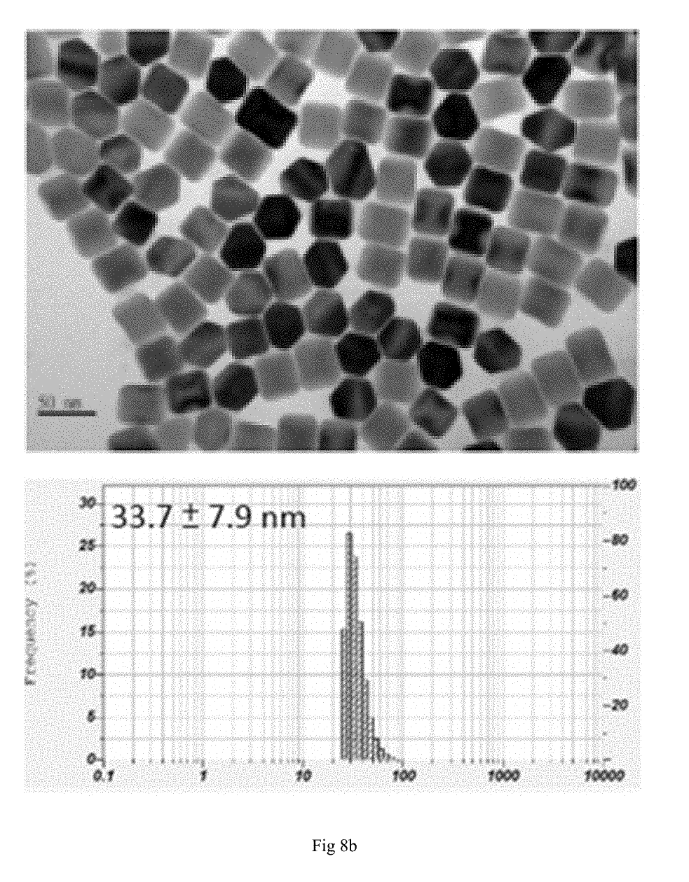

As shown in FIG. 8a, near-infrared light irradiation can be used to emit light in the wavelength band of 540 nm and 660 nm via energy transfer. The 543 nm green light can be absorbed by the outer rose bengal to induce the formation of ¹O₂ and ROS to facilitate photodynamic therapy, while 980 nm NIR can be used for near-infrared luminescence imaging. As shown in FIG. 8b, the particle size analysis results were 27 nm (core) and 33.7 nm (core/shell), respectively. Measurement of the formation of ¹O₂ and ROS led to a 30% drop in the amount of ABDA luminescence, confirming the production of reactive oxygen species. The phototoxicity of cells showed that the experimental group was 30-40% under the same conditions and 80-90% in the control group.

### EXAMPLE 5

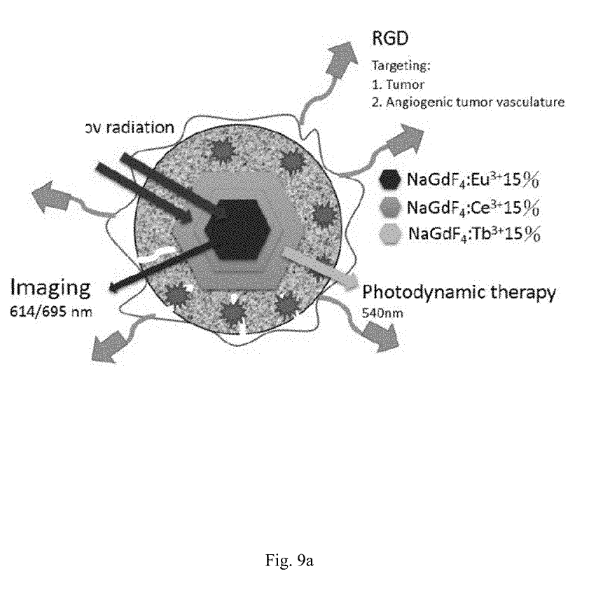

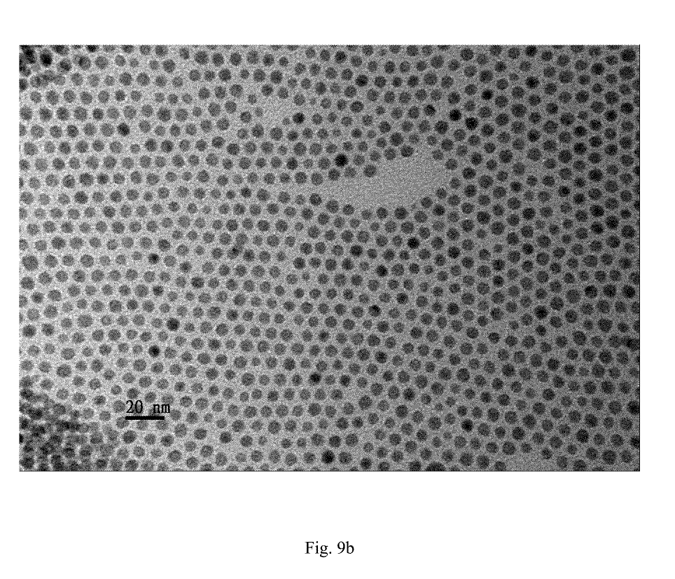

The structure from the core layer to the shell layer in order of NaGdF4:Eu3+(5-30%) @ NaGdF4:Ce3+(5-50%) @ NaGdF4: Tb3+(5-30%) @ PAH-RB @ PEG3k-folic acid. This material can be stimulated by cherenkov radiation and has the potential of both imaging and treatment. As shown in FIG. 9a, B radionuclides such as ¹⁸FDG can be used as a source of cherenkov radiation to emit light in the 614 nm, 695 nm, and 540 nm bands via energy transfer. Its 540 nm green light can be absorbed by the outer layer of rose bengal to induce ¹O₂ and ROS generation for photodynamic therapy, while 614 nm and 695 nm red light can be applied to fluoroscopy. As shown in FIG. 9b, the particle size analysis results were 4.8 nm (core) and 6.7 nm (core/shell), respectively.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A lanthanide-doped fluoride nanocomposite, which comprises the structure of:
a core layer, is consisting of a first compound, wherein the first compound has an alkali fluoride compound with a base material, a first lanthanide metal and a second lanthanide metal;
a middle layer covering the core layer, is consisting of a second compound, wherein the second compound has the alkali fluoride compound with the base material and the first lanthanide metal; and
an outer shell layer covering the middle layer, is consisting of a third compound, wherein the third compound has the alkali fluoride compound with the base material and the first lanthanide metal or a third lanthanide metal.

2. The lanthanide-doped fluoride nanocomposite of claim 1, wherein the first compound is NaLnF₄:Yb³⁺,Er³⁺, NaLnF₄:Yb³⁻,Nd³⁺, NaLnF₄:Gd³⁺,Eu³⁺ or NaLnF₄:Eu³⁺, wherein Ln represents the base material is selected from the group of Y, Gd, La, Lu and lanthanide.

3. The lanthanide-doped fluoride nanocomposite of claim 2, wherein when the first compound is NaLuF₄:Gd³⁺,Eu³⁺, the second compound is NaLuF₄:Gd³⁺, and the third compound is NaLuF₄:Gd³⁺,Tb³⁺.

4. The lanthanide-doped fluoride nanocomposite of claim 3, wherein the mole percentage of Gd ³⁺ and Eu³⁺0 in the first compound is 20%˜50% and 5%˜30%; the mole percentage of Gd³⁺ in the second compound is 20%˜50%; wherein the mole percentage of Gd³⁺ and Tb³⁺ in the third compound is 20%˜50% and 5%˜30%.

5. The lanthanide-doped fluoride nanocomposite of claim 2, wherein when the first compound is NaYF₄:Yb ³⁺,Er³⁺, the second compound is NaYF₄:Yb ³⁻, and the third compound is NaYF₄:Nd³⁺,Yb³⁺.

6. The lanthanide-doped fluoride nanocomposite of claim 5, wherein the mole percentage of Yb ³⁺ and Er³⁺ in the first compound is 5%˜50% and 0.2%˜5%; the mole percentage of Yb³⁻ in the second compound is 5%˜50%; wherein the mole percentage of Nd³⁺ and Yb³⁺ in the third compound is 5%˜50% and 5%˜50%.

7. The lanthanide-doped fluoride nanocomposite of claim 2, wherein when the first compound is NaYF₄:Yb 3⁺,Nd³⁺, the second compound is NaYF₄:Yb³⁺, and the third compound is NaYF₄:Yb³⁺,Tm³⁺.

8. The lanthanide-doped fluoride nanocomposite of claim 5, wherein the mole percentage of Yb³⁺ and Nd ³⁻ in the first compound is 5%˜50% and 5%˜20%; the mole percentage of Yb³⁺ in the second compound is 5%˜50%; wherein the mole percentage of Yb³⁺ and Tm³⁻ in the third compound is 5%˜50% and 0.2%˜5%.

9. The lanthanide-doped fluoride nanocomposite of claim 2, wherein when the first compound is NaYF₄:Yb³⁺,Nd³⁺, the second compound is NaYF₄:Yb³⁺, and the third compound is NaYF₄:Yb³⁺,Er³⁺.

10. The lanthanide-doped fluoride nanocomposite of claim 9, wherein the mole percentage of Yb ³⁺ and Nd ³⁻ the first compound is 5%˜50% and 5%˜20%; the mole percentage of Yb³⁺ in the second compound is 5%˜50%; wherein the mole percentage of Yb³⁺ and Er³⁺ in the third compound is 5%˜50% and 0.2%˜5%.

11. The lanthanide-doped fluoride nanocomposite of claim 2, wherein when the first compound is NaGdF₄:Eu³⁺, the second compound is NaGdF₄:Ce³⁺, and the third compound is NaGdF₄:Tb³⁺.

12. The lanthanide-doped fluoride nanocomposite of claim 11, wherein the mole percentage of Eu³⁺ in the first compound is 5%˜30%; the mole percentage of Ce³⁺ in the second compound is 5%˜50%; wherein the mole percentage of Tb³⁺ in the third compound is 5%˜30%.

13. The lanthanide-doped fluoride nanocomposite of claim 1, wherein the outer shell layer is modified by a polyallylamine hydrochloride, poly acrylic acid, silicon dioxide or titanium oxide.

14. The lanthanide-doped fluoride nanocomposite of claim 13, wherein the surface of the shell layer is further modified with a photosensitizer or a photothermal sensitizer.

15. The lanthanide-doped fluoride nanocomposite of claim 14, wherein the surface of the shell layer is further coated with a biocompatible molecule, and links a target molecule.

16. A method of making a lanthanide-doped fluoride nanocomposite comprising the steps of:
a) preparing a core layer by mixing 0.25-1 millimole of a basic acetate with 6-10 milliliters of oleic acid and 15 mL of octadecene, further doping a first lanthanide metal or a second lanthanide metal, then obtaining a first solution;
b) heating the first solution in 160° C.˜190° C. for a period of time, then the reaction temperature was reduced to 65° C.;
c) dissolving 2.5 mmol of sodium hydroxide (NaOH) and 4 mmol of ammonium tetrafluoride (NH4F) in 10 ml of methanol to obtain a second solution;
d) adding the second solution into the first solution and evaporating the methanol completely to obtain a third solution;
e) heating the third solution in 280° C.˜310° C. for a period of time, the reaction temperature was reduced to room temperature;
f) adding 15˜25 mL of ethanol into the third solution to precipitate, collecting a precipitated product after the reaction is completed;
g) adding the precipitated product into a non-polar solvent to obtain a first compound, wherein the first compound is the core layer;
h) preparing a middle shell, further doping said first lanthanide series metal, and repeating steps a) to g) to obtain a second compound which is used as the middle shell covering said core layer; and
i) preparing a shell layer, further doping the first lanthanide series metal or the third lanthanoid series metal, repeating steps a) to g), obtaining a third compound which is used as the outer shell layer covering the middle shell layer, then obtaining a core shell nano material

17. The method of making a lanthanide-doped fluoride nanocomposite as claim 16, wherein said base acetate is a material containing at least one element selected from the group consisting of Y, Gd, La, Lu and lanthanide-acetate groups.

18. The method of making a lanthanide-doped fluoride nanocomposite as claim 16, wherein the first lanthanide-based metal is Gd, Yb, or Ce.

19. The method of making a lanthanide-doped fluoride nanocomposite as claim 16, wherein the second lanthanide-based metal is Eu, Er or Nd.

20. The method of making a lanthanide-doped fluoride nanocomposite as claim 16, wherein the third lanthanide-based metal is Gd, Nd, Tm or Tb.

21. The method of making a lanthanide-doped fluoride nanocomposite as claim 16, wherein the non-polar solvent is n-hexane or cyclohexane.

22. The method of making a lanthanide-doped fluoride nanocomposite as claim 16, wherein when obtaining the second compound, further adding 0.1 to 0.5 mmol of the first compound in Step d) into the first solution.

23. The method of making a lanthanide-doped fluoride nanocomposite as claim 16, wherein when obtaining the third compound, further adding 0.1 to 0.5 mmol of the second compound in Step d) into the first solution.
